(19) United States
(12) Patent Application Publication
(10) Pub. No.: US 2004/0000109 A1
(43) Pub. Date: Jan. 1, 2004

(54) Frame assembly and method for installing a window pane in an opening of a panel

(75) Inventors: Luc Bourassa, Saint-Majorique (CA); Douglas Kidd, Keller, TX (US)

Correspondence Address: MERCHANT & GOULD PC, P.O. BOX 2903, MINNEAPOLIS, MN, 55402-0903, US

(73) Assignee: Canimex Inc., Drummondville (CA)

(21) Appl. No.: 10/418,438

(22) Filed: Apr. 16, 2003

(30) Foreign Application Priority Data
Apr. 19, 2002 (CA) 2,382,661

(51) Int. Cl. E06B 3/30

(52) U.S. Cl. 52/204.54

(57) ABSTRACT

A frame assembly (1) and a method for installing a window pane (3) in an opening (5) of a panel (7). The assembly (1) includes an outer frame (9) having connecting devices (15) and an abutment member (17). The assembly (1) also includes an inner frame (19) provided with first connecting devices (25). The first connecting devices (25) cooperate with the connecting devices (15) of the outer frame (9) for disengageably connecting the outer and inner frames (9, 19). The assembly (1) also includes locking device (28) having at least one flexible element (31) cooperating with one of the frames (9, 19) for locking the locking device (28) in locking position, and at least one contacting element (33) for holding the window pane (3) in position with aid of the abutment member (17) when the locking device (28) is in the locking position.

### FIELD OF THE INVENTION

The present invention relates to a frame assembly and a method for installing a window pane in an opening of a panel, and particularly a garage door panel.

### BACKGROUND OF THE INVENTION

In the garage door field, window frame assemblies normally consist of an exterior frame and an interior frame. In order to install a window pane in an opening of a panel, the exterior frame is mounted on the outer side of the panel, while the window pane and the inner frame are mounted on the inner side of the panel. This results in the window pane being squeezed between the exterior and interior frames. Such installation requires two persons in a non-factory situation, that is to say one person on the outer side that handles the exterior frame and another person on the inner side to handle the window pane and the interior frame. The frames are typically screwed together, but can alternatively be snapped together.

If the window pane needs to be replaced, due to breakage for example, then it is possible to disassemble the frames that were connected together by means of screws. However, most existing frames are not strong enough to support the disassembling because these are designed with the idea of permanent installation, and are often broken during the replacement procedure. Consequently, the whole frame must be changed. This is especially true of frames that are snapped together. Such frames are typically provided with male studs and corresponding female studs that make the frames practically impossible to disassemble without destroying them. The disassembling procedure also requires two persons and is therefore inefficient and time-consuming.

Therefore, as explained above, the assembly and disassembly of existing frames is complicated, labour intensive and time consuming. Furthermore, existing frames do not allow an easy replacement of the window pane in case of breakage for example.

Accordingly, there exists a need in the market for a frame assembly for mounting a window pane in an opening of a panel that can be assembled by a single person and that can be disassembled also by a single person without destroying the frames.

Known in the art, there are the following U.S. patent documents, which describe different window frame assemblies: U.S. Pat. Nos. 3,760,543 (MCALLISTER); 3,903,669 (PEASE, Jr. et al.); 4,021,967 (MULDER et al.); 4,241,556 (BURSK); 4,525,961 (HANSEN); 4,839,989 (MCCONNELL); 4,841,696 (MILLER); 4,897,975 (ARTWICK et al); 5,018,330 (LEWKOWITZ); 5,133,168 (NEILLY et al.); 5,189,862 (LAFLEUR); 5,283,995 (RICHTER); 5,323,579 (RUFF); 5,369,923 (SCHILT); 5,430,982 (BANE); 5,497,588 (MARTIN et al.); 5,577,355 (LEONELLI); 5,644,881 (NEILLY); 5,852,910 (ZEBEDEE); 6,151,849 (TWIGG et al.); 6,318,037 (HANSEN); 6,434,898 (WARD et al.) and U.S. patent application Ser. No. 2003/0041539 (BERNACKI et al.). None of these patent documents disclose window frame assemblies that properly solve all the problems identified above in an efficient manner.

### SUMMARY OF THE INVENTION

An object of the present invention is to provide a frame assembly, and a method for installing a window pane in an opening of a panel, where the frame assembly may be assembled and disassembled by a single person in a more efficient and less time-consuming manner that prior art frames and methods.

According to the present invention, there is provided a frame assembly for installing a window pane in an opening of a panel, the assembly comprising:

an outer frame having a peripheral wall shaped for fitting and extending into the opening, on an outer side of the panel, the wall having along periphery thereof connecting means and an abutment member;

an inner frame having a peripheral wall shaped for fitting and extending into the opening, on an inner side of the panel, the wall of the inner frame having along periphery thereof first connecting means cooperating with the connecting means of the outer frame for disengageably connecting the outer and inner frames; and

a locking means having at least one flexible element cooperating with one of the frames for locking the locking means in locking position, and at least one contacting element for holding the window pane in position with aid of the abutment member when the locking means is in said locking position.

According to another aspect of the present invention, there is provided a method for installing a window pane in an opening of a panel, the method comprising the steps of:

a) mounting an outer frame on an outer side of the panel, the outer frame having a peripheral wall shaped for fitting and extending into the opening, the wall having along periphery thereof connecting means and an abutment member;

b) mounting an inner frame on an inner side of the panel, the inner frame having a peripheral wall shaped for fitting and extending into the opening, the wall of the inner frame having along periphery thereof first connecting means cooperating with the connecting means of the outer frame for disengageably connecting the outer and inner frames;

c) after steps a) and b), mounting the window pane into the opening on the inner side against the abutment member of the outer frame; and

d) after step c), mounting a locking means on the inner frame to hold the window pane against the abutment member, the locking means having at least one flexible element cooperating with one of the frames for locking the locking means in locking position, and at least one contacting element for holding the window pane in position with aid of the abutment member when the locking means is in said locking position.

Preferably, an advantage of the present invention is that the window pane may be replaced without having to disassemble the inner and outer frames.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

FIG. 1 is a perspective exploded view of a frame assembly according to a preferred embodiment of the present invention, in relation to a panel and a window pane.

FIG. 2 is a perspective top view of an element of the frame assembly shown in FIG. 1.

FIG. 3 is a more detailed view of a portion of the element shown in FIG. 2, encircled by line III.

FIG. 4 is perspective top view of another element of the frame assembly shown in FIG. 1.

FIG. 5 is a more detailed view of a portion of the element shown in FIG. 4, encircled by line V.

FIG. 6 is a more detailed view of another portion of the element shown in FIG. 4, encircled by line VI.

FIG. 7 is a perspective top view of another element shown in FIG. 1.

FIG. 8 is a more detailed view of a portion of the element shown in FIG. 7, encircled by line VIII.

FIG. 9 is a partial perspective top view of the frame assembly shown in FIG. 1, in an assembled position, in relation to the panel and the window pane.

FIG. 10 is a partial perspective top view of the frame assembly shown in FIG. 1, in an assembled position, without the element shown in FIG. 7, in relation to the panel and a screwdriver (shown partially).

FIG. 11 is a cross section view along line XI-XI of FIG. 11, with the screwdriver of FIG. 10, shown in another position.

FIG. 12 is a perspective exploded view of a frame assembly according to a second preferred embodiment of the present invention, in relation to a panel and a window pane.

FIG. 13 is a perspective top view of an element of the frame assembly shown in FIG. 12.

FIG. 14 is a more detailed view of a portion of the element shown in FIG. 13, encircled by line XIV.

FIG. 15 is a more detailed view of a portion of the element shown in FIG. 13, encircled by line XV.

FIG. 16 is a more detailed view of a portion of the element shown in FIG. 13, encircled by line XVI.

FIG. 17 is perspective bottom view of another element of the frame assembly shown in FIG. 12.

FIG. 18 is a more detailed view of a portion of the element shown in FIG. 17, encircled by line XVIII.

FIG. 19 is perspective top view of the element of the frame assembly shown in FIG. 17.

FIG. 20 is a partial perspective cross section top view of the frame assembly shown in FIG. 12, in an assembled position.

FIG. 21 is a more detailed view of a portion of the frame assembly shown in FIG. 20, encircled by line XXI.

FIGS. 22 and 24 are perspective top views of a portion of another element shown in FIG. 12.

FIG. 23 is a more detailed view of a portion of the element shown in FIG. 22, encircled by line XXIII.

FIG. 25 is a perspective top view of a portion of another element shown in FIG. 12.

FIG. 26 is a more detailed view of a portion of the element shown in FIG. 25, encircled by line XXVI.

FIG. 27 is a more detailed view of a portion of the element shown in FIG. 24, encircled by line XXVII.

FIG. 28 is a more detailed view of a portion of the element shown in FIG. 24, encircled by line XXVIII.

### DETAILED DESCRIPTION OF THE INVENTION

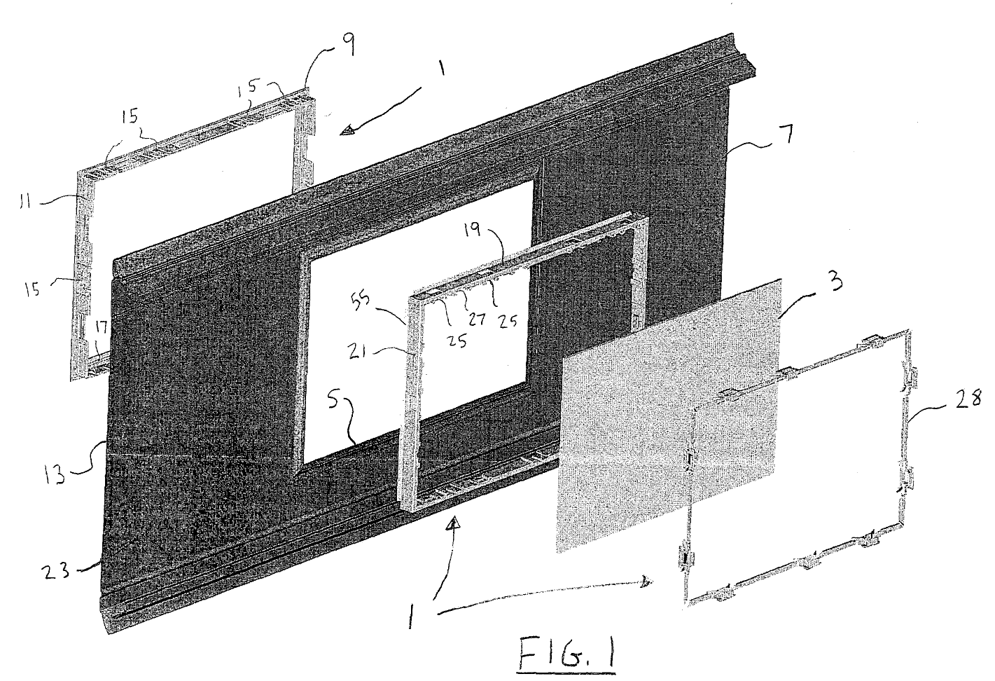

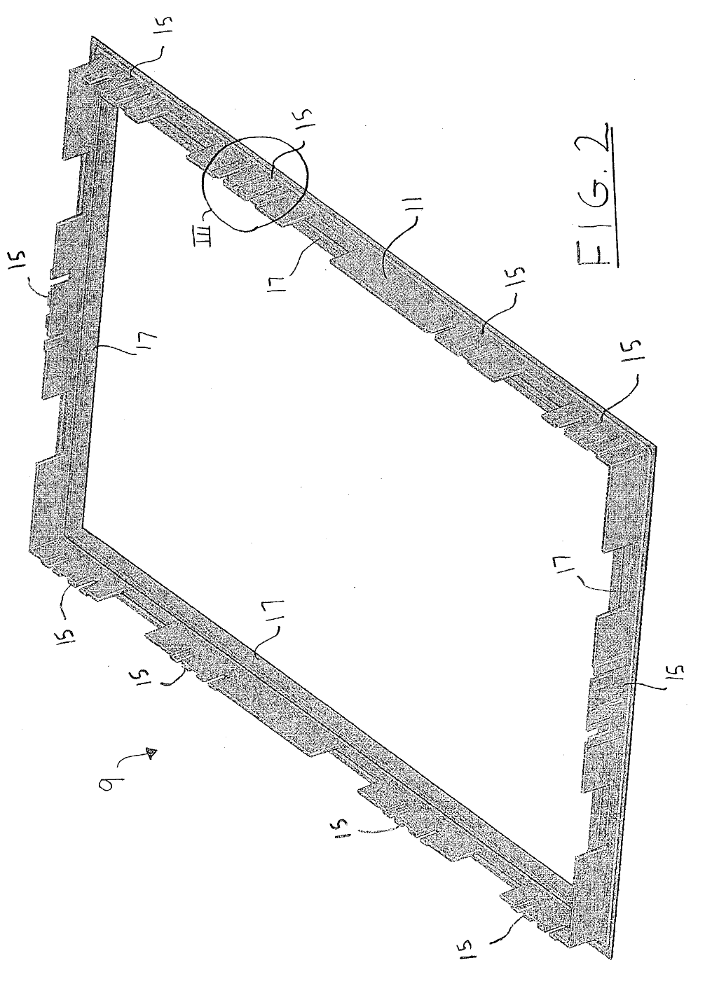

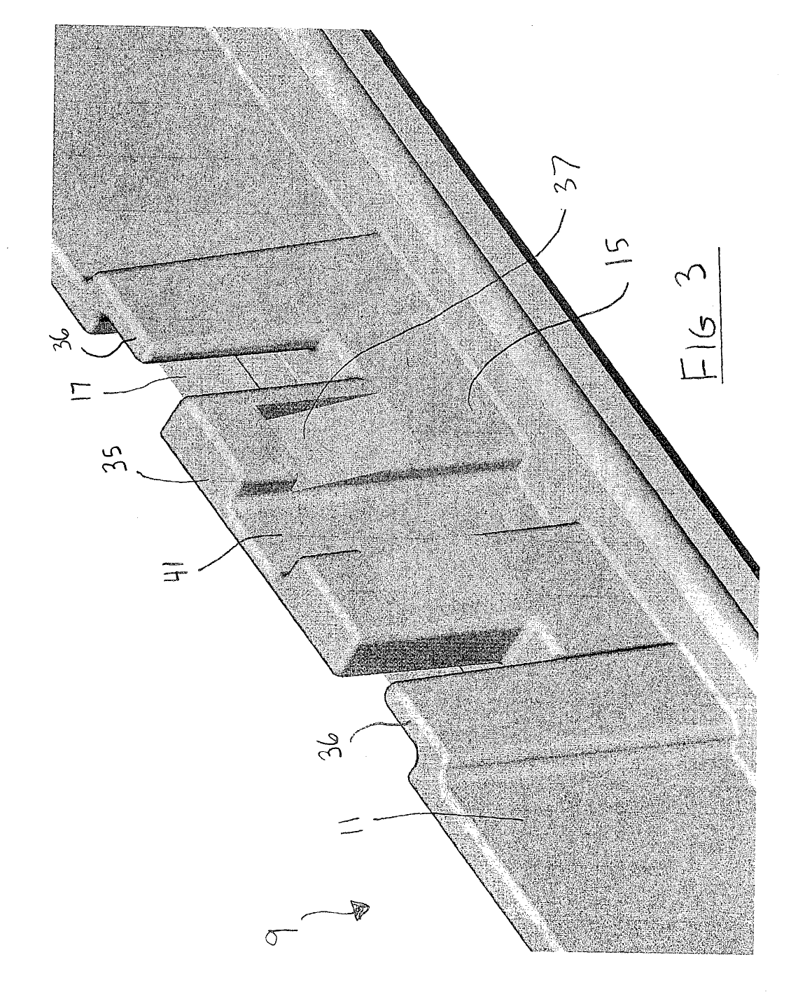

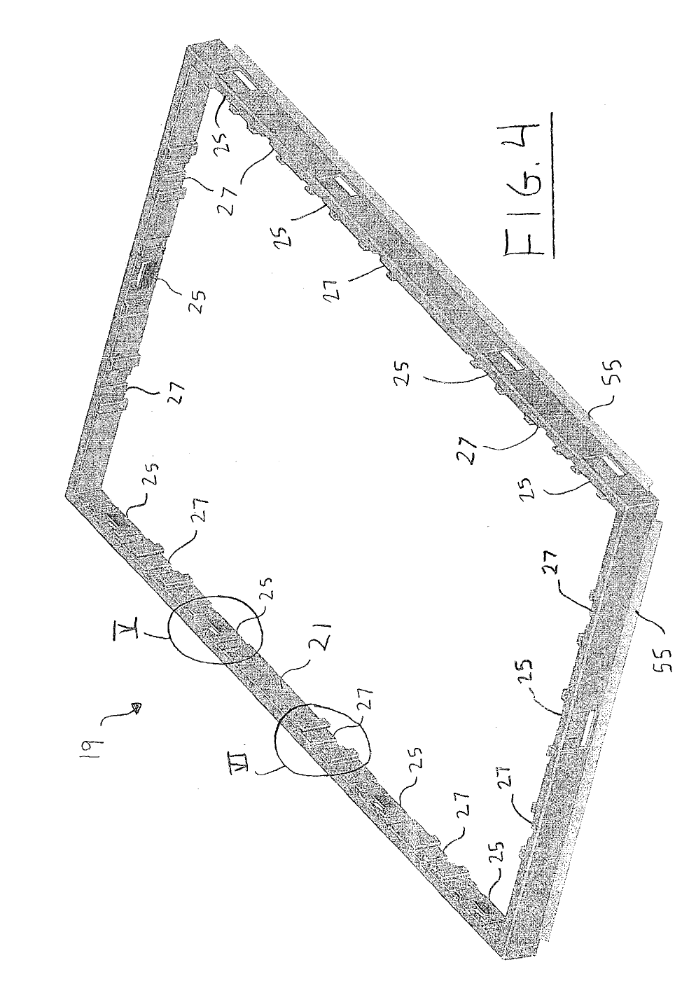

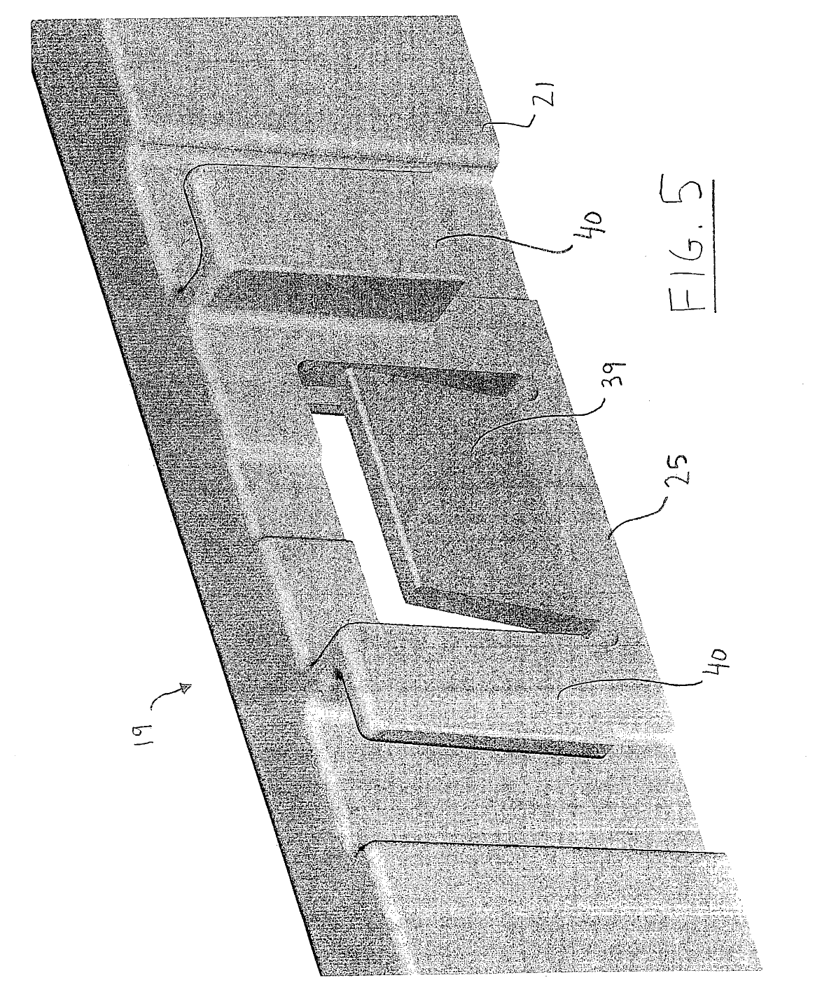

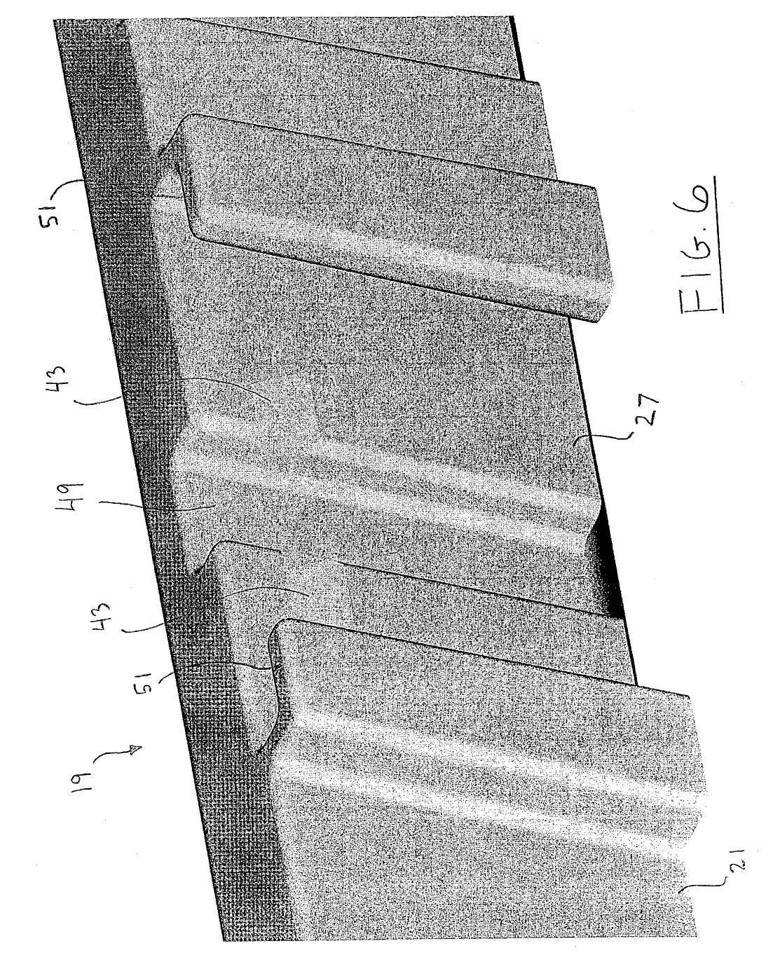

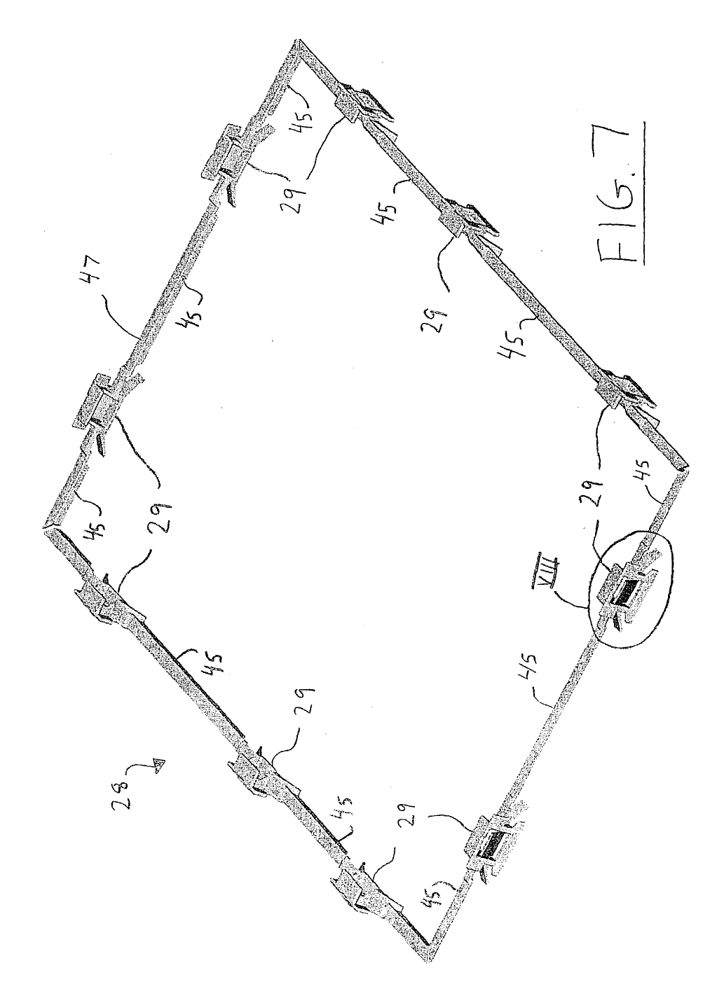

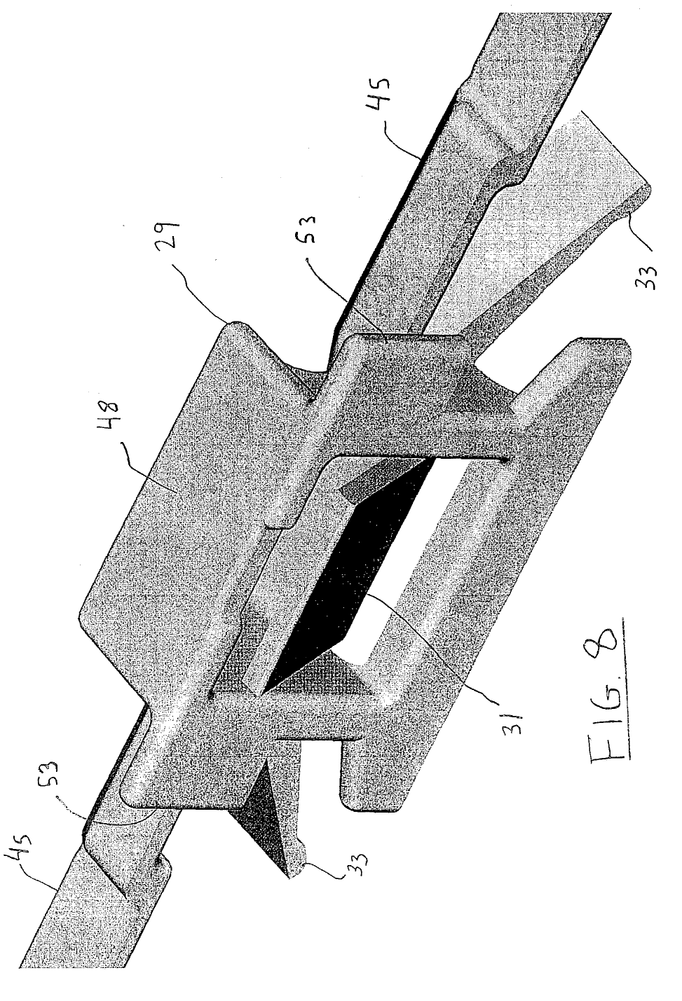

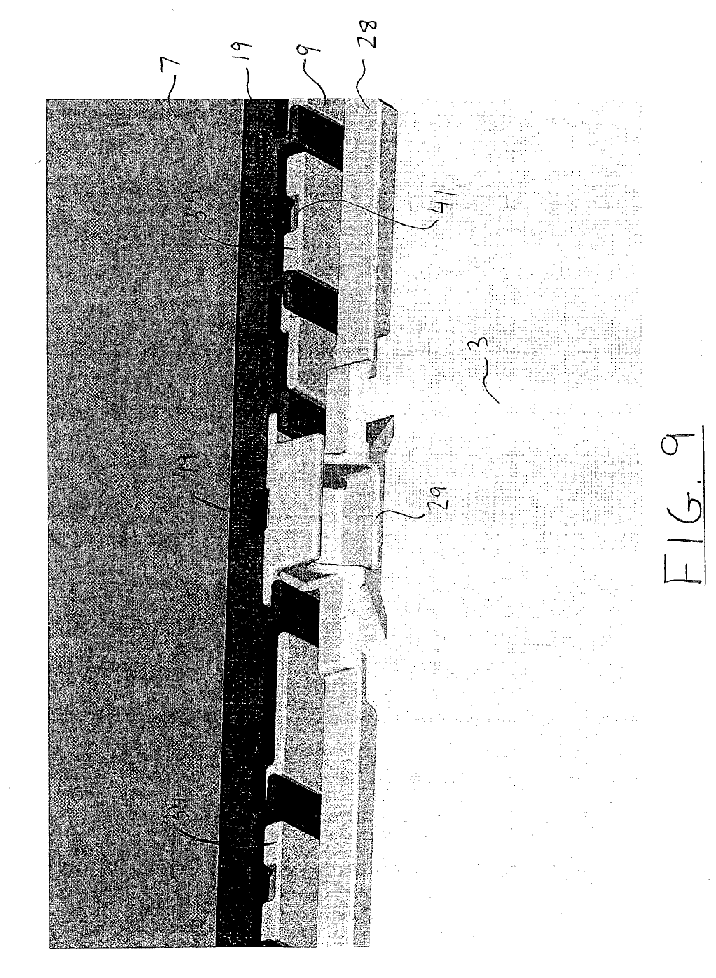

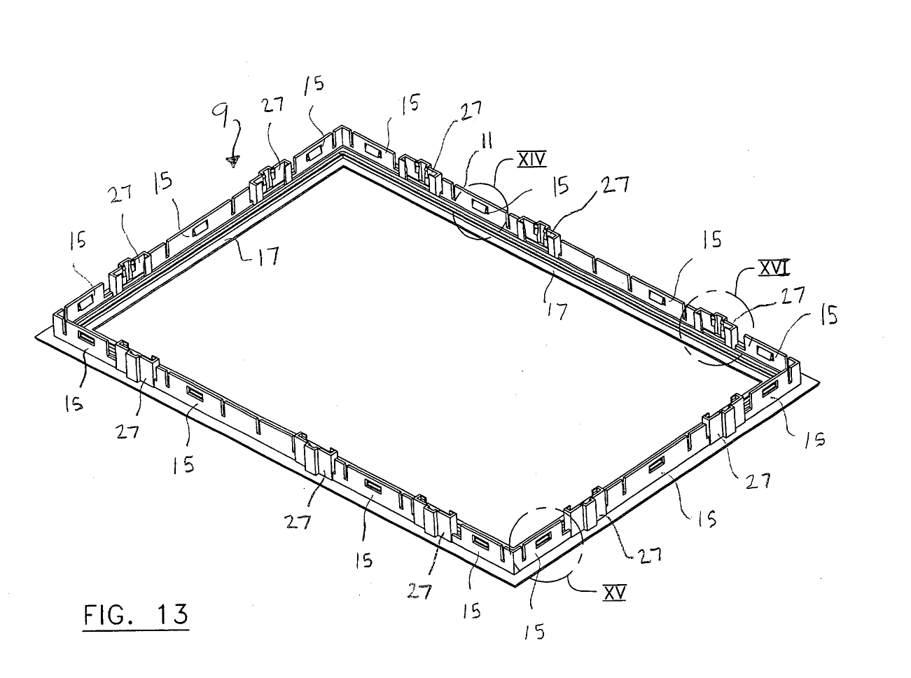

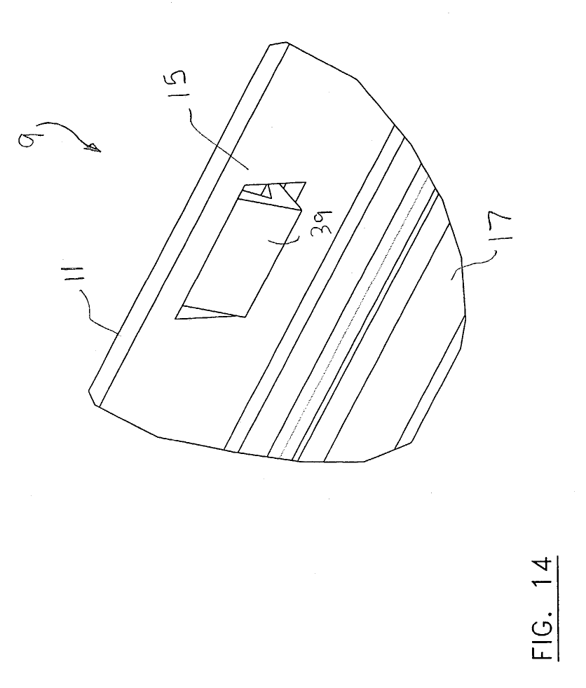

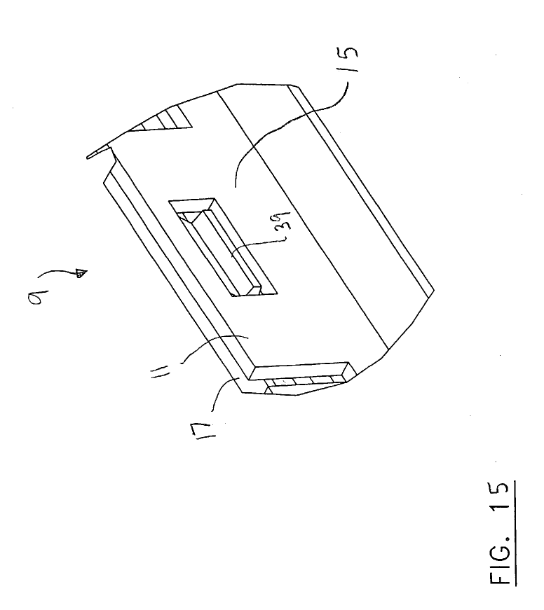

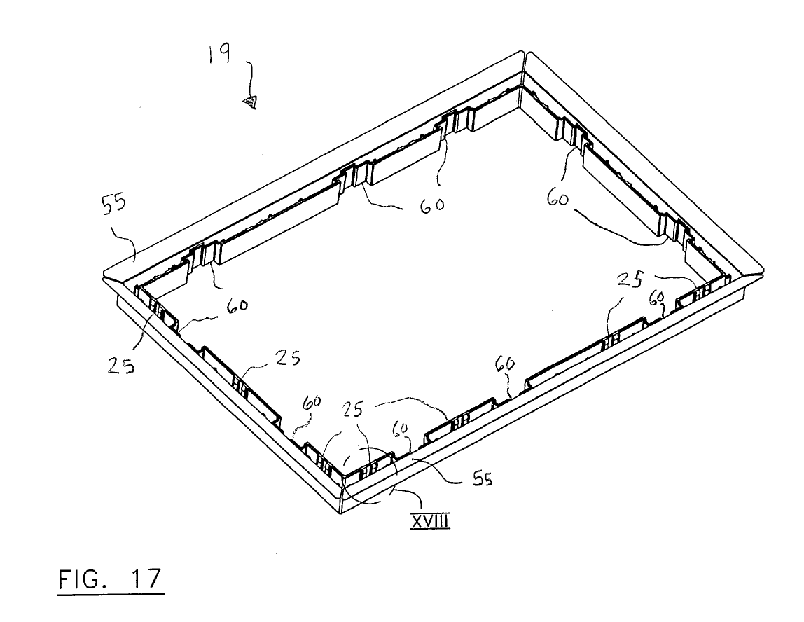

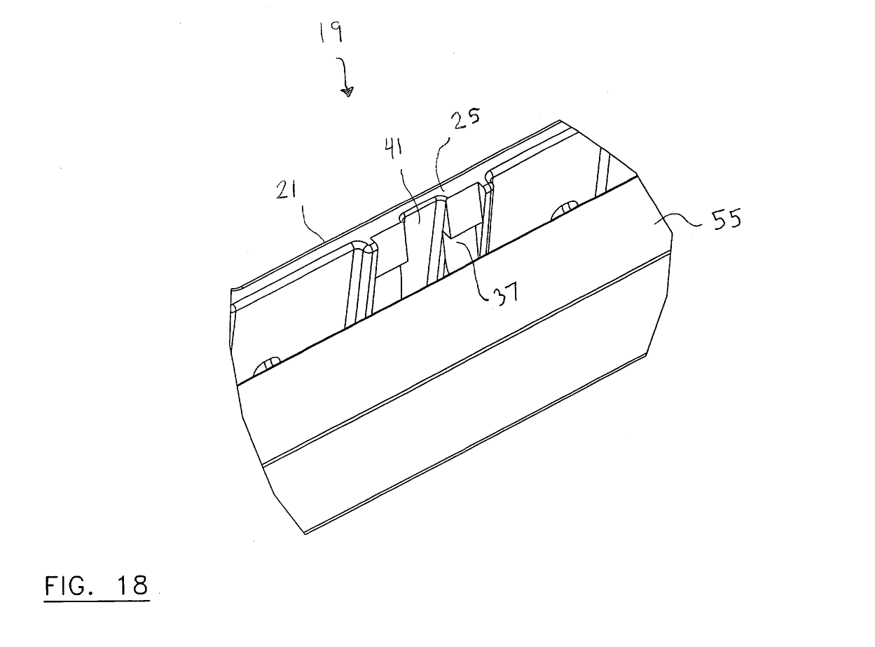

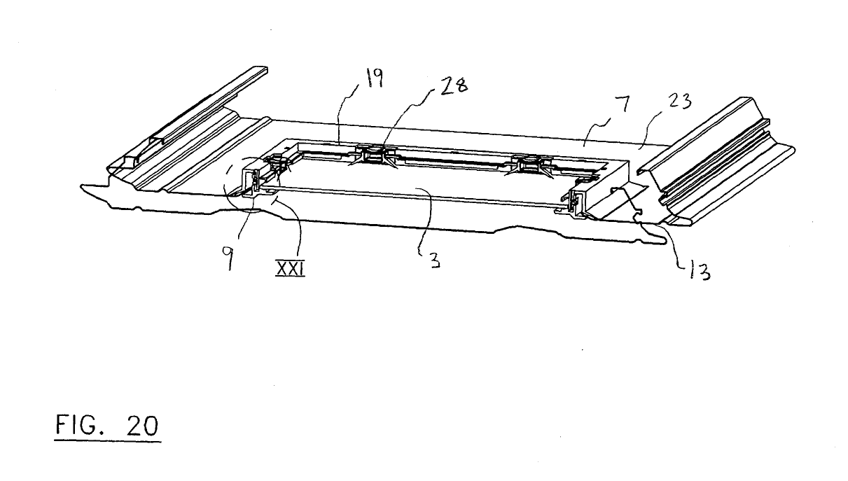

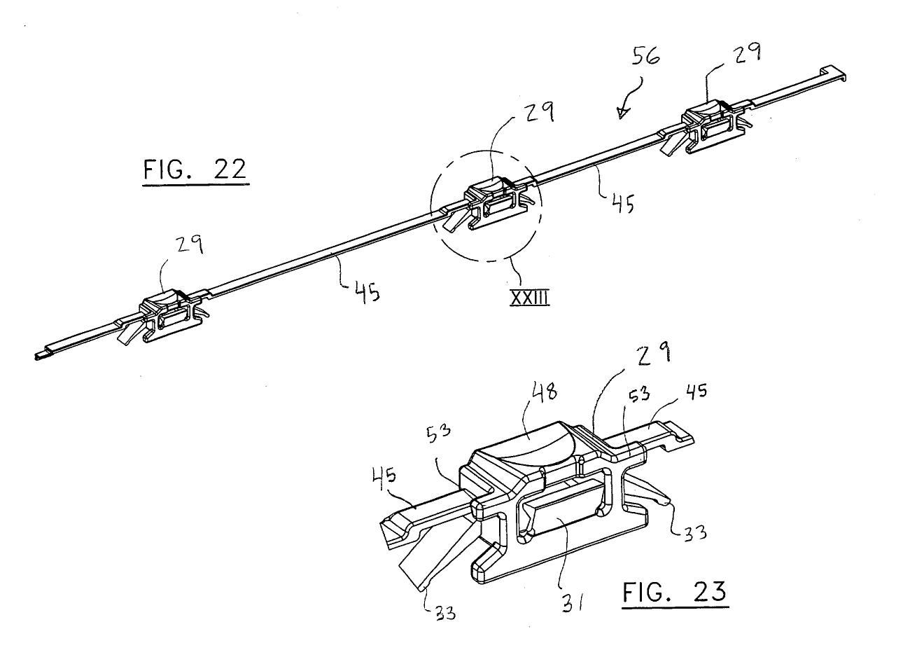

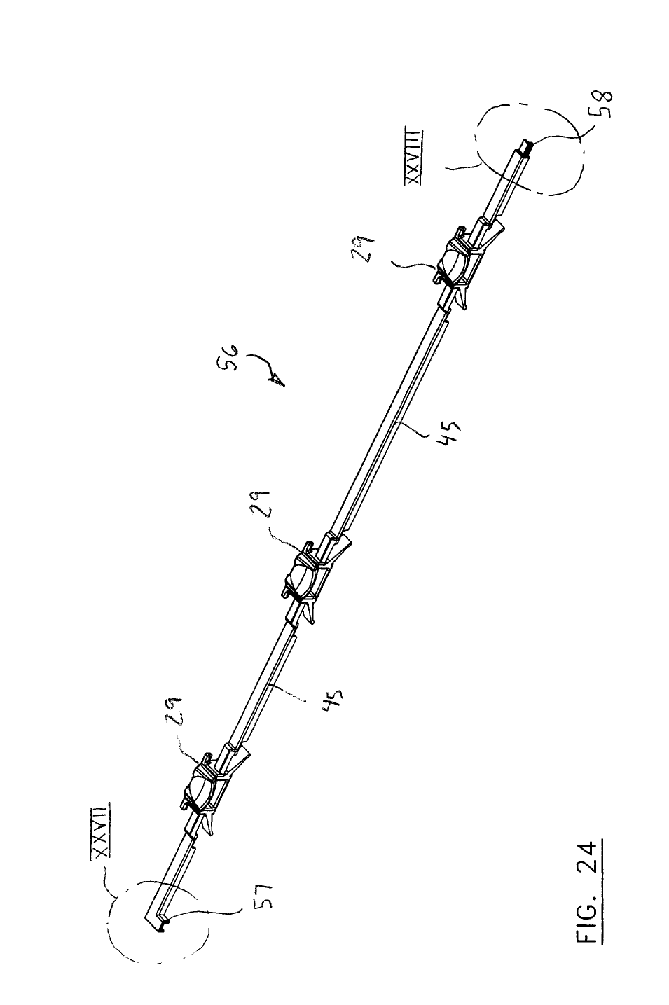

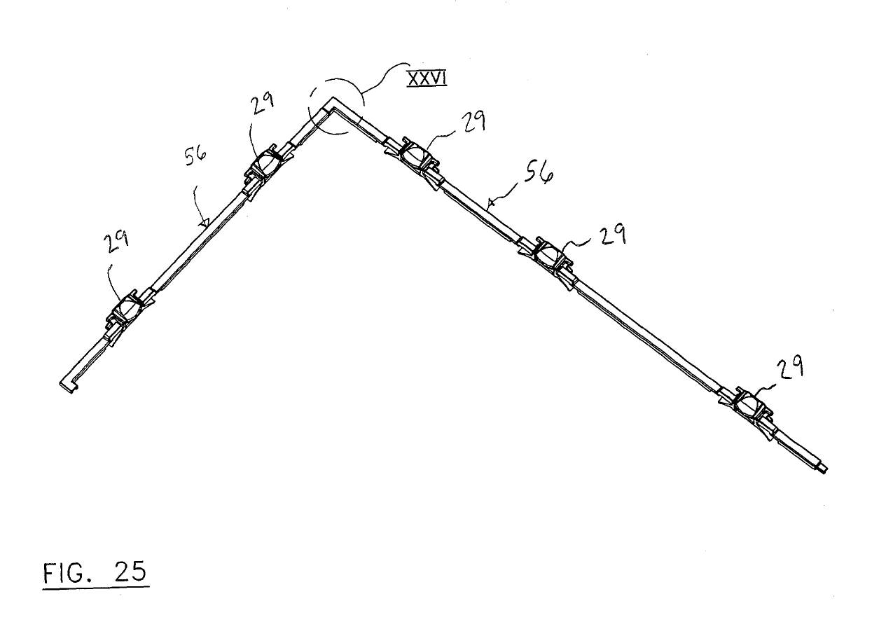

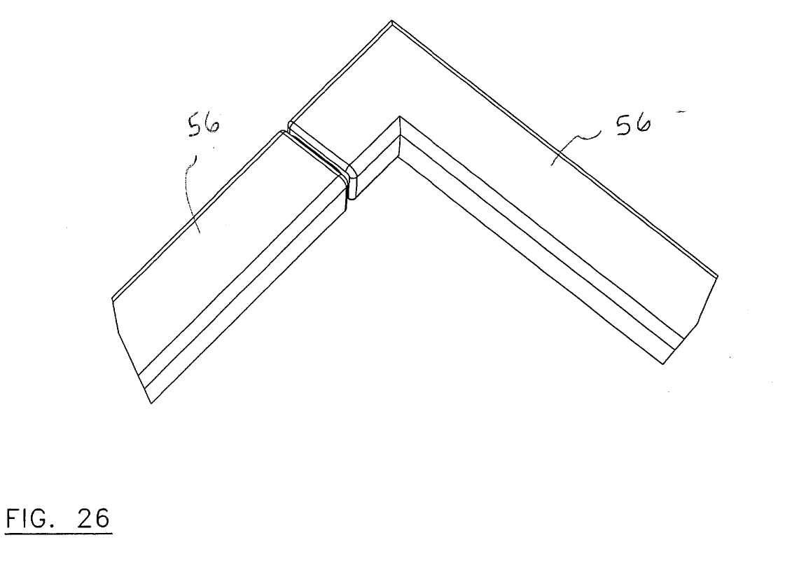

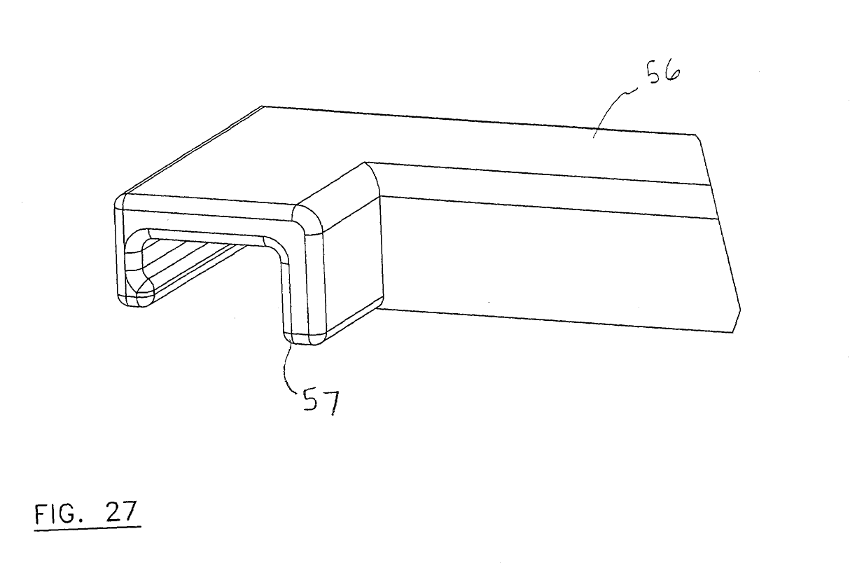

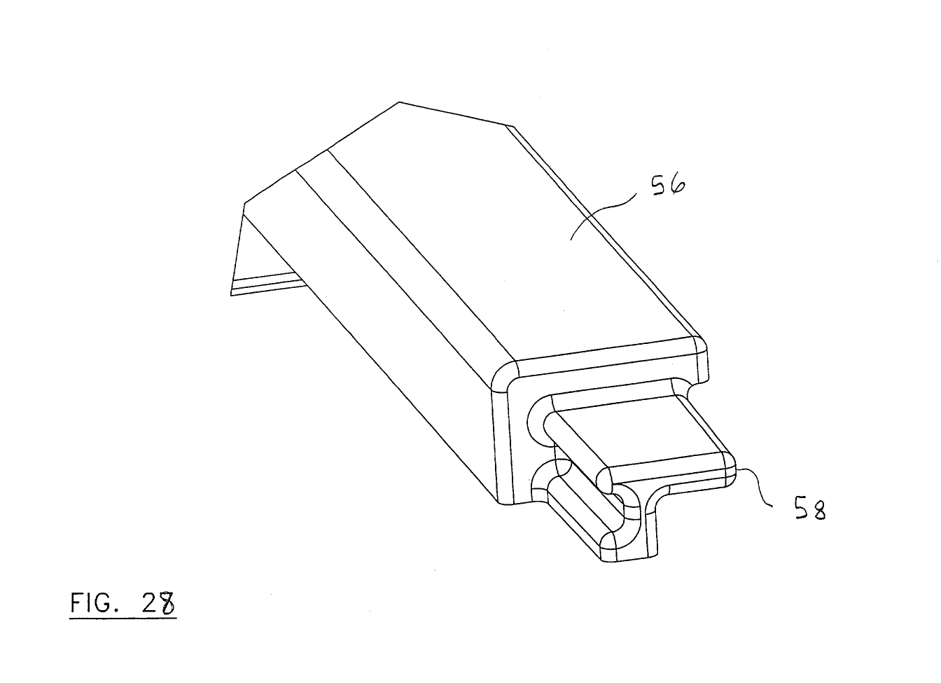

Referring to FIGS. 1 and 12, there are shown frame assemblies 1 according to first and second preferred embodiments of the present invention for installing a window pane 3 in an opening 5 of a panel 7. Each assembly 1 includes an outer frame 9 having a peripheral wall 11 shaped for fitting and extending into the opening 5, on an outer side 13 of the panel 7. The wall 11 has along periphery thereof connecting devices 15, and an abutment member 17, which are best illustrated in FIGS. 2 and 3 with regard to the first embodiment and in FIGS. 13 to 15 with regard to the second embodiment. The frame assembly 1 also includes an inner frame 19 having a peripheral wall 21 shaped for fitting and extending into the opening 5, on an inner side 23 of the panel 7. The wall 21 of the inner frame 19 has along periphery thereof first connecting devices 25 cooperating with the connecting devices 15 of the outer frame 9 for disengageably connecting the outer and inner frames 9, 19. These first connecting devices 25 are best illustrated in FIGS. 4 and 5 with regard to the first preferred embodiment, and in FIGS. 17 and 18 with regard to the second preferred embodiment. Each frame assembly 1 also includes a locking device 28, which is best illustrated in FIGS. 7 and 8 with regard to the first embodiment, and in FIGS. 22 to 28 with regard to the second embodiment. The locking device 28 has at least one flexible element 31 cooperating with one of the frames 9, 19 for locking the locking device 28 in locking position, and at least one contacting element 33 for holding the window pane 3 in position with aid of the abutment member 17 when the locking device 28 is in the locking position, as shown for example in FIG. 9 with regard to the first embodiment and in FIG. 20 with regard to the second embodiment. Preferably, the frames 9, 19 and locking device 28 are each made of a single piece of injection molded plastic.

Referring to FIGS. 3 and 5, the connecting devices 15 of the outer frame 9 may include a plurality of tab members 35 each having a transversal side notch 37, and the first connecting devices 25 of the inner frame 19 may include a plurality of flexible elements 39 cooperating with the corresponding transversal side notches 37 for connecting the frames 9, 19 together. In FIG. 5, the flexible element 39 is shown in its normal position with its top edge forming an angle with respect to the wall 21. During assembly and disassembly, the flexible elements 39 are pushed out of their normal position and pivot with respect to their base.

The actual shape of the connecting devices 15 of the outer frame 9 and the first connecting devices 25 of the inner frame 19 may vary from what is illustrated in FIGS. 1 to 5. Indeed, the shapes of the connecting devices 15, 25 may be interchanged as shown for example in FIGS. 12 to 19 with regard to the second embodiment. Several other shapes for these connecting devices 15, 25 may be conceived as those skilled in the art will understand.

It should also be understood that the purpose of the connecting devices 15, 25 is to disengageably connect the outer and inner frames 9, 19. Therefore, these connecting devices 15, 25 can alternatively be screws, bolts, threaded holes, or any other suitable set of disengageable connectors.

In actual practice, it is possible that some of the flexible elements 39 provided on the inner frames 19, as shown in FIG. 5, may be broken or be rendered unusable during handling. In such a case, it is still possible to connect the two frames 9, 19 together by using screws that are installed at the places where the flexible elements 39 have failed.

It should also be noted that the number of these connecting devices 15, 25 may vary considerably. Indeed, one may design a single connecting device 15 that is disengageably connectable to a single first connecting device 25. These connecting devices 15, 25 would be sized to cover most or all of the periphery of the walls 11, 21. This would result in a single flexible element 39 cooperating with a single corresponding transversal side notch 37.

Referring to FIG. 3, each of the tab members 35 may be provided with a recessed channel 41 allowing access to the flexible elements 39 of the first connecting devices 25 from the inner side 23.

In order to facilitate the access to the flexible element 39 during disassembly of the frame assembly 1, the recessed channel 41 is shaped deeper into the tab member 35 than the adjacent transversal side notch 37. As illustrated in FIG. 3, the recessed channel 41 is located in the middle of the tab member 35 and two transversal side notches 37 are located on each side thereof. Each transversal side notch 37 has a skewed V-shape form, with a sloped face conforming with a sloped portion of the flexible element 39 and a stopper face abutting against the edge of the flexible element 39 when the frames 9, 19 are connected together.

Referring to FIGS. 3 and 5, the wall 11 of the outer frame 9 is provided with guiding portions 36, and the wall 21 of the inner frame 19 is provided with guiding elements 40 shaped for cooperating with the corresponding guiding portions 36 of the outer frame 9. As illustrated, the guiding portions 36 may consist of L-shaped edges that are spaced at a certain distance from both sides of each tab member 35. The guiding elements 40 may take the form of pairs L-shaped arms provided along the inner periphery of the of the wall 21 of the inner frame 19, on both sides of each flexible element 39. As those skilled in the art will understand, the exact position of the guiding portions 36 and guiding elements 40 on the frames 9, 19 may vary.

Preferably, as is best illustrated in FIG. 6, the inner frame 19 is provided with second connecting devices 27 cooperating with the at least one flexible element 31 for locking the locking device 28 in the locking position.

Referring to FIGS. 6 to 8, the second connecting devices 27 may include a plurality of transversal side notches 43 provided on the wall 21 of the inner frame 19. These side notches 43 may be similar in shape to the side notches 37 provided on the connecting device 15 of the outer frame 9. The locking device 28 may include several locking members 29. As best shown in FIG. 8, each of the locking members 29 is provided with a flexible element 31 and a contacting element 33. The flexible elements 31 cooperate with the corresponding transversal side notches 43 for locking the locking device 28 in locking position. The contacting elements 33 may be V-shaped and each of the locking members 29 may be provided with a grasping portion 48 for handling the locking members 29 by a user.

As those skilled in the art will understand, the actual shape of the locking device 28 and the second connecting devices 27 may vary from what is illustrated in the Figures. Indeed, similarly as explained above with regard to the connecting devices 15, 25, one may design a single locking member 29 cooperating with a single second connecting device 27. In such case, the single locking member 29 and the single second connecting device 27 would be sized to cover most or all of the periphery of the window pane 3. This would result in a single flexible element 31 cooperating with a single corresponding transversal side notch 43.

Referring to FIG. 7, the locking device 28 may include links 45 for linking the locking members 29 into a locking frame 47 shaped for fitting and extending into the inner frame 19 from the inner side 23. However, it is not necessary for these locking members 29 to be linked together as each locking member 29 may be installed independently one by one by a user.

Referring to FIGS. 22 to 28, the locking frame 47 may include at least two sections 56 each provided with female and male extremities 57, 58 for disengageably connecting the at least two sections 56. Preferably, the locking frame 47 may include four disengageably connectable sections. It is also possible to have one section of the frame provided with two male extremities but in that case another section would have two female extremities.

Referring to FIG. 6, the wall 21 of the inner frame 19 may be provided with recessed channels 49 allowing access to the flexible elements 31 from the inner side 23. Again, similarly as for the recessed channel 41 described above, in order to facilitate the access to the flexible element 31 during disassembly of the locking frame 47 from the inner frame 19, the recessed channel 49 is shaped deeper into the wall 21 than the adjacent transversal side notch 43. As illustrated, the recessed channel 49 is located between two adjacent transversal notches 43.

Referring to FIGS. 6 and 8, the wall 21 of the inner frame 19 may be provided with guiding elements 51, and each of the locking members 29 may be provided with side edges 53 shaped for cooperating with the corresponding guiding elements 51 of the inner frame 19. Again, the exact position of the guiding elements 51 may vary as those skilled in the art will understand.

Referring to FIG. 4, the inner frame 19 may be provided with a peripheral flexible lip 55 shaped for contacting the panel 7 on the inner side 23. This flexible lip 55 permits adjusting the frames 9, 19 according to a thickness of the panel 7.

Referring to FIGS. 12 to 15, as mentioned above, the connecting devices 15 provided on the outer frame 9 according to the second preferred embodiment of the present invention may be similar in shape to the first connecting devices 25 provided on the inner frame 19 that are illustrated in FIGS. 4 and 5 according to the first preferred embodiment.

Referring to FIGS. 17 to 19, the first connecting devices 25 provided on the inner frame 19 according to the second preferred embodiment of the present invention may be similar in shape to the connecting devices 15 provided on the outer frame 9 that are illustrated in FIGS. 2 and 3 according to the first preferred embodiment.

In this case, the connecting devices 15 may each be provided with a flexible element 39, whereas the first connecting devices 25 may each be provided with a transversal side notch 37 and a recessed channel 41 for the similar purposes as described above.

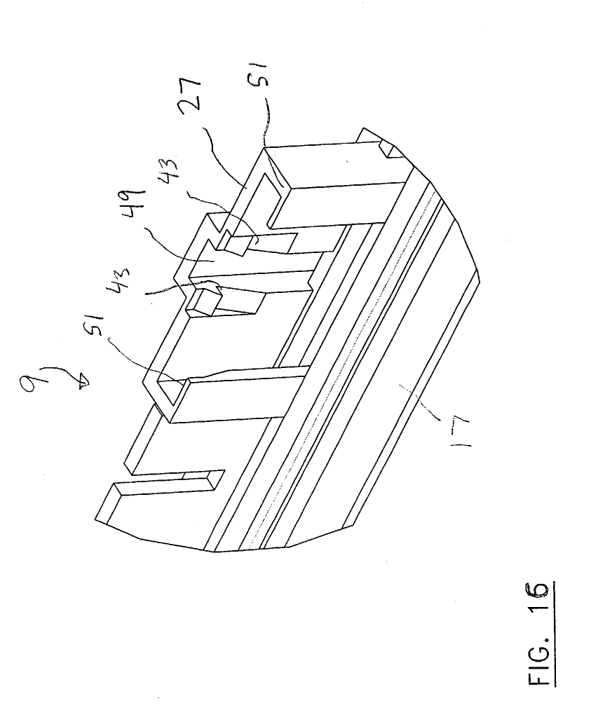

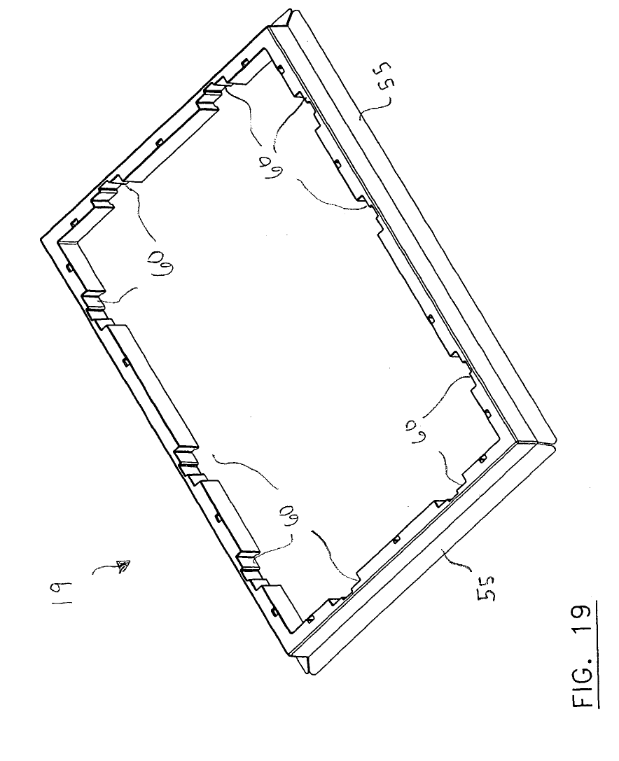

Referring to FIGS. 13 and 16, the second connecting devices 27 may be provided on the outer frame 9. In such a case, the inner frame 19 may be provided with recessed channels 60, as shown for example in FIG. 19, for allowing passage to the locking members 29.

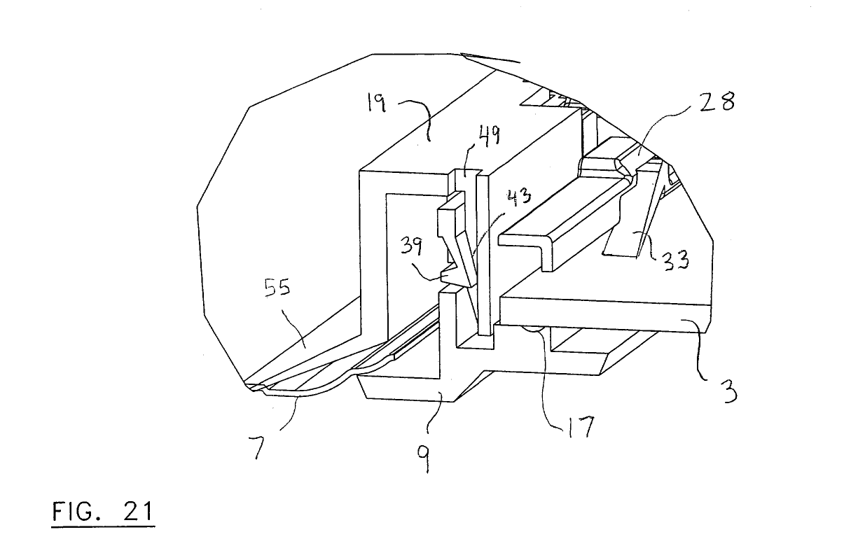

Referring to FIGS. 1 to 21, a method for installing the window pane 3 in the opening 5 of the panel 7 essentially includes the steps of:

a) mounting an outer frame 9 on an outer side 13 of the panel 7, the outer frame 9 having a peripheral wall 11 shaped for fitting and extending into the opening 5, the wall 11 having along periphery thereof connecting devices 15 and an abutment member 17, which are best illustrated in FIGS. 2, 3, 13 to 15;

b) mounting an inner frame 19 on an inner side 23 of the panel 7, the inner frame 19 having a peripheral wall 21 shaped for fitting and extending into the opening 5, the wall 21 of the inner frame 19 having along periphery thereof first connecting devices 25 cooperating with the connecting devices 15 of the outer frame 9 for disengageably connecting the outer and inner frames 9, 19, which are best illustrated in FIGS. 4, 5, 17 to 19;

c) after steps a) and b), mounting the window pane 3 into the opening 5 on the inner side 23 against the abutment member 17 of the outer frame 9; and

d) after step c), mounting a locking device 28, which is best shown in FIGS. 7 to 9 and 22 to 28, on the inner frame 19 to hold the window pane 3 against the abutment member 17, the locking device 28 having at least one flexible element 31 cooperating with one of the frames 9, 19 for locking the locking device 28 in locking position, and at least one contacting element 33 for holding the window pane 3 in position with aid of the abutment member 17 when the locking device 28 is in the locking position.

Preferably, in step b), the inner frame 19 is provided with second connecting devices 27, as shown in FIG. 6, cooperating with the at least one flexible element 31 for locking the locking device 28 in the locking position.

Preferably, in step b), the inner frame 19 is provided with a peripheral flexible lip 55 shaped for contacting the panel 7 on the inner side 23 and the method further comprises the step of adjusting the flexible lip 55 according to a thickness of the panel 7.

Preferably, in step a) of the above method, the connecting devices 15 of the outer frame 9 include a plurality of tab members 35 each having a transversal side notch 37, as shown for example in FIG. 3 and, in step b), the first connecting devices 25 include a plurality of flexible elements 39, as shown for example in FIG. 5, cooperating with the corresponding transversal side notches 37 for connecting the frames 9, 19 together.

Preferably, in step a) of the above method, each of the tab members 35 is provided with a recessed channel 41, as shown for example in FIG. 3, for allowing access to the flexible elements 39 of the first connecting means 25 from the inner side 23.

Preferably, in step b) of the above method, the second connecting devices 27 include a plurality of transversal side notches 43 provided on the wall 21 of the inner frame 19, as shown for example in FIG. 6. Furthermore, in step d) of the above method, the locking device 28 may include several locking members 29 with the same characteristics as discussed above in this regard with reference to FIGS. 7 to 9. Also, preferably, in step b) of the above method, the wall 21 of the inner, frame 19 is provided with recessed channels 49, as shown for example in FIG. 6, allowing access to the flexible elements 31 of the locking device 28 from the inner side 23.

Preferably, the above method further includes, for removing the window pane 3, the steps of:

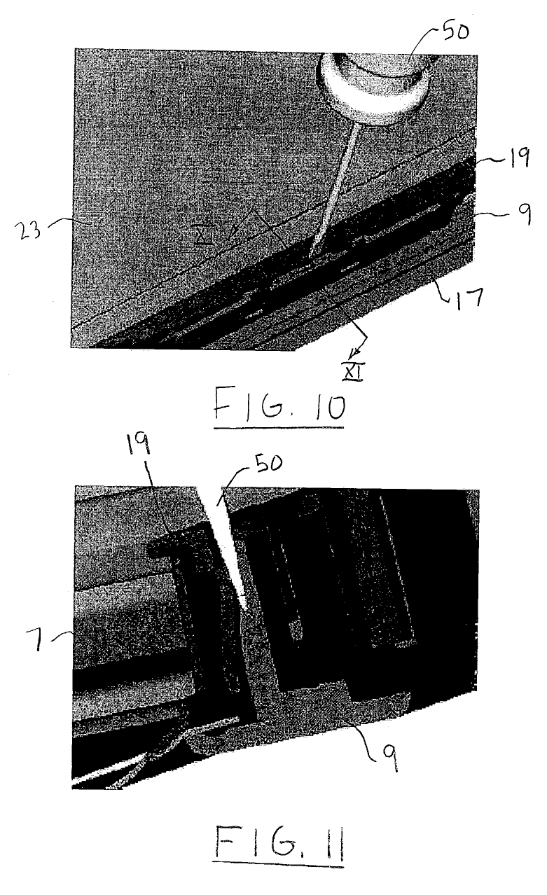

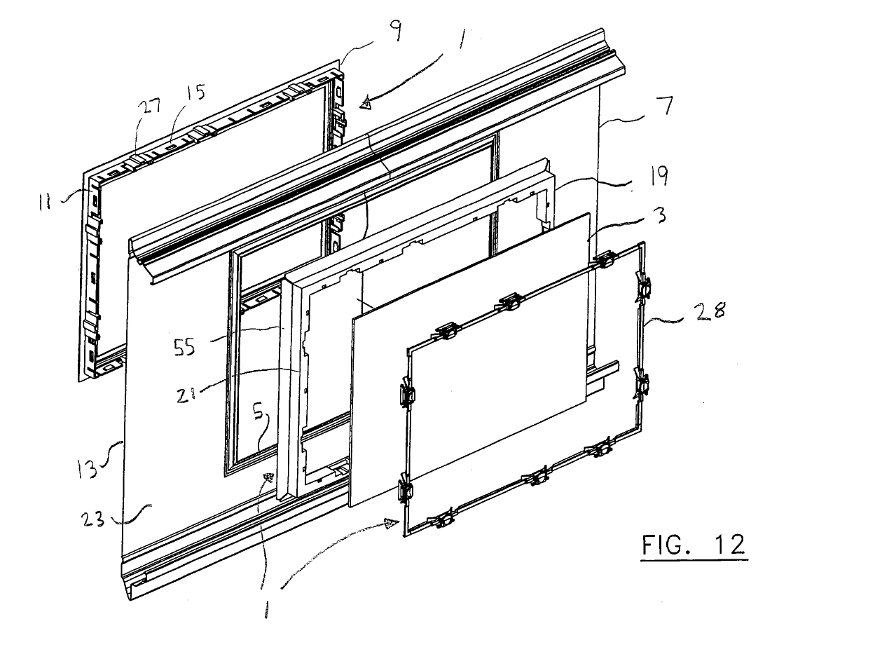

e) after step d), inserting a tool 50, such as a screwdriver, into each of the recessed channels 49 of the inner frame 19 for disengaging the locking members 29 from the inner frame 19, as shown for example in FIGS. 10 and 11; and

f) after step e), removing the window pane 3.

Preferably, the above method further includes, for disengaging the frames 9, 19 from each other, the step of:

g) after step f), inserting the tool 50 into each of the recessed channels 41 of the outer frame 9 for disengaging the frames 9, 19 from each other, as shown for example in FIGS. 10 and 11.

Preferably, the above method further includes, for mounting a new window pane 3, the steps of:

g) after step f), mounting the new window pane 3 into the opening 5 on the inner side 23 against the abutment member 17 of the outer frame 9; and

h) after step g), connecting the locking members 29 to the inner frame 19 for locking the locking device 28 in locking position.

The frame assembly 1 according to the present invention for mounting a window pane in an opening of a panel can be assembled by a single person and can be disassembled also by a single person without unscrewing or destroying the frames in a more efficient and less time-consuming manner that prior art frames and methods.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A frame assembly (1) for installing a window pane (3) in an opening (5) of a panel (7), the assembly (1) comprising:
an outer frame (9) having a peripheral wall (11) shaped for fitting and extending into the opening (5), on an outer side (13) of the panel (7), the wall (11) having along periphery thereof connecting means (15) and an abutment member (17);
an inner frame (19) having a peripheral wall (21) shaped for fitting and extending into the opening (5), on an inner side (23) of the panel (7), the wall (21) of the inner frame (19) having along periphery thereof first connecting means (25) cooperating with the connecting means (15) of the outer frame (9) for disengageably connecting the outer and inner frames (9, 19); and
a locking means (28) having at least one flexible element (31) cooperating with one of the frames (9, 19) for locking the locking means (28) in locking position, and at least one contacting element (33) for holding the window pane (3) in position with aid of the abutment member (17) when the locking means (28) is in said locking position.

2. The frame assembly (1) according to claim 1, wherein the inner frame (19) is provided with a second connecting means (27) cooperating with the at least one flexible element (31) for locking the locking means (28) in said locking position.

3. The frame assembly (1) according to claim 2, wherein the connecting means (15) of the outer frame (9) includes a plurality of tab members (35) each having a transversal side notch (37) and wherein the first connecting means (25) includes a plurality of flexible elements (39) cooperating with the corresponding transversal side notches (37) for connecting the frames (9, 19) together.

4. The frame assembly (1) according to claim 3, wherein each of said tab members (35) is provided with a recessed channel (41) allowing access to the flexible elements (39) of the first connecting means (25) from the inner side (23).

5. The frame assembly (1) according to claim 4, wherein the wall (11) of the outer frame (9) is provided with guiding portions (36), and the wall (21) of the inner frame (19) is provided with guiding elements (40) shaped for cooperating with the corresponding guiding portions (36) of the outer frame (9).

6. The frame assembly (1) according to claim 2, wherein the second connecting means (27) includes a plurality of transversal side notches (43) provided on the wall (21) of the inner frame (19), the locking means (28) includes several locking members (29), said at least one flexible element (31) comprises several flexible elements (31), and said at least one contacting member (33) comprises several contacting elements (33), each of the locking members (29) being each provided with one of said flexible elements (31) and one of said contacting elements (33), said flexible elements (31) cooperating with the corresponding transversal side notches (43) for locking the locking means (28) in locking position.

7. The frame assembly (1) according to claim 6, wherein the locking means (28) comprises links (45) for linking the locking members (29) into a locking frame (47) shaped for fitting and extending into the inner frame (19) from the inner side (23).

8. The frame assembly (1) according to claim 7, wherein the locking frame (47) comprises at least two sections (56) each provided with female and male extremities (57, 58) for disengageably connecting the at least two sections (56).

9. The frame assembly (1) according to claim 6, wherein the contacting elements (33) are V-shaped and each of said locking members (29) has a grasping portion (48) for handling thereof by a user.

10. The frame assembly (1) according to claim 6, wherein the wall (21) of the inner frame (19) is provided with recessed channels (49) allowing access to said flexible elements (31) from the inner side (23).

11. The frame assembly (1) according to claim 10, wherein the wall (21) of the inner frame (19) is provided with guiding elements (51), and each of said locking members (29) is provided with side edges (53) shaped for cooperating with the corresponding guiding elements (51) of the inner frame (19).

12. The frame assembly (1) according to claim 1, wherein the inner frame (19) is provided with a peripheral flexible lip (55) shaped for contacting the panel (7) on the inner side (23).

13. The frame assembly (1) according to claim 1, wherein the frames (9, 19) and locking means (28) are each made of a single piece of injection molded plastic.

14. A method for installing a window pane (3) in an opening (5) of a panel (7), the method comprising the steps of:
a) mounting an outer frame (9) on an outer side (13) of the panel (7), the outer frame (9) having a peripheral wall (11) shaped for fitting and extending into the opening (5), the wall (11) having along periphery thereof connecting means (15) and an abutment member (17);
b) mounting an inner frame (19) on an inner side (23) of the panel (7), the inner frame (19) having a peripheral wall (21) shaped for fitting and extending into the opening (5), the wall (21) of the inner frame (19) having along periphery thereof first connecting means (25) cooperating with the connecting means (15) of the outer frame (9) for disengageably connecting the outer and inner frames (9, 19);
c) after steps a) and b), mounting the window pane (3) into the opening (5) on the inner side (23) against the abutment member (17) of the outer frame (9); and
d) after step c), mounting a locking means (28) on the inner frame (19) to hold the window pane (3) against the abutment member (17), the locking means (28) having at least one flexible element (31) cooperating with one of the frames (9, 19) for locking the locking means (28) in locking position, and at least one contacting element (33) for holding the window pane (3) in position with aid of the abutment member (17) when the locking means (28) is in said locking position.

15. The method according to claim 14, wherein, in step b), the inner frame (19) is provided with a second connecting means (27) cooperating with the at least one flexible element (31) for locking the locking means (28) in said locking position.

16. The method according to claim 14, wherein, in step b), the inner frame (19) is provided with a peripheral flexible lip (55) shaped for contacting the panel (7) on the inner side (23) and the method further comprises the step of adjusting the flexible lip (55) according to a thickness of the panel (7).

17. The method according to claim 15, wherein, in step a), the connecting means (15) of the outer frame (9) includes a plurality of tab members (35) each having a transversal side notch (37) and wherein, in step b), the first connecting means (25) includes a plurality of flexible elements (39) cooperating with the corresponding transversal side notches (37) for connecting the frames (9, 19) together.

18. The method according to claim 17, wherein, in step a), each of said tab members (35) is provided with a recessed channel (41) for allowing access to the flexible elements (39) of the first connecting means (25) from the inner side (23).

19. The method according to claim 18, wherein, in step b), the second connecting means (27) includes a plurality of transversal side notches (43) provided on the wall (21) of the inner frame (19), in step d), the locking means (28) includes several locking members (29), said at least one flexible element (31) of the locking means (28) comprises several flexible elements (31), and said at least one contacting member (33) comprises several contacting elements (33), each of the locking members (29) being each provided with one of said flexible elements (31) of the locking means (28) and one of said contacting elements (33), said flexible elements (31) of the locking means (28) cooperating with the corresponding transversal side notches (43) for locking the locking means (28) in locking position.

20. The method according to claim 19, wherein, in step b), the wall (21) of the inner frame (19) is provided with recessed channels (49) allowing access to the flexible elements (31) of the locking means (28) from the inner side (23).

21. The method according to claim 20, further comprising, for removing the window pane (3), the steps of:
e) after step d), inserting a tool (50) into each of the recessed channels (49) of the inner frame (19) for disengaging the locking members (29) from the inner frame (19); and
f) after step e), removing the window pane (3).

22. The method according to claim 21, further comprising, for disengaging the frames (9, 19) from each other, the step of:
g) after step f), inserting the tool (50) into each of the recessed channels (41) of the outer frame (9) for disengaging the frames (9, 19) from each other.

23. The method according to claim 21, further comprising, for mounting a new window pane (3), the steps of:
g) after step f), mounting the new window pane (3) into the opening (5) on the inner side (23) against the abutment member (17) of the outer frame (9); and
h) after step g), connecting the locking members (29) to the inner frame (19) for locking the locking means (28) in locking position.
